(19) United States
(12) Patent Application Publication
(10) Pub. No.: US 2008/0270430 A1
(43) Pub. Date: Oct. 30, 2008

(54) FILE MANAGEMENT SYSTEM, FILE MANAGEMENT METHOD, SUPPORT DEVICE THEREOF, AND PROGRAM THEREOF

(76) Inventor: SHIGENORI KOBAYASHI, Tokyo (JP)

Correspondence Address: NEC CORPORATION OF AMERICA, 6535 N. STATE HWY 161, IRVING, TX, 75039, US

(21) Appl. No.: 12/108,316

(22) Filed: Apr. 23, 2008

(30) Foreign Application Priority Data
Apr. 25, 2007 (JP) 115213/2007

(51) Int. Cl. G06F 17/30

(52) U.S. Cl. 707/100; 707/E17.005

(57) ABSTRACT

A file management system includes a management server and a support device. The support device checks whether or not a program file satisfies a check rule for each program file, and sending the program file satisfying the check rule to the management server.

### CROSS-REFERENCE TO RELATED APPLICATION

This application is based upon and claims the benefit of priority from Japanese patent application No. 2007-115213, filed on Apr. 25, 2007, the disclosure of which is incorporated herein in its entirety by reference.

### BACKGROUND OF THE INVENTION

The present invention relates to a file management system, a file management method, a support device thereof, and a program thereof, and more particularly relates to a file management system, a file management method, a support device thereof, and a program thereof which are capable of checking the quality of a program based on different software development phases.

Program files made up of software systems and applications such as source codes and build scripts are usually stored and operated in a repository of a file management server by utilizing a support device.

Generally, source codes and build scripts are obtained from a repository and utilized as build tools when creating software systems and applications.

Under these types of circumstances, when the quality of the program stored in the repository is poor, the quality of the software system and the created applications also is poor.

Moreover identifying what program in the repository has a problem requires a great amount of time. And the repair tasks of the program having the problem and re-release of the program having the problem are also very expensive.

Therefore, a large amount of time and considerable expenses were required for discovering the problem and resolving the problem. In the result, when carrying out projects for developing applications and software systems, above-mentioned problem is caused.

Managing the quality of programs stored in the repository of the file management server was recognized as essential for resolving this problem in the related art. So software developers verified the program quality and managers carried out checks. However these checks were unable to eliminate misses and errors.

For example, JP-A No. 2001-034461 discloses a software management device which checks the quality of the source code within the software result database and which displays those check results. The software management device can therefore prompt the developer to make corrections when a problem occurs in the source code.

Moreover, a software management device which monitors different type of quality markers of the source code within the repository, which displays statistical information, and which advises correcting the problem point is disclosed.

However, utilizing these software management devices causes the following problems.

A first problem was that the quality check was made after registration in the repository so that problem points in the program were sometimes discovered after no longer being readily accessible by the developer.

These devices therefore had the problem that much wasted effort and huge costs were required to make corrections.

Using these software management devices causes the further problem that poor quality programs are registered in the repository so that third parties such as the manager, customers or auditors could not be guaranteed that there were no problems or defects.

On the other hand, JP-A No. 2005-316685 discloses a program management device in which a quality check of the program is made based on the quality condition defining information before registering (check-in) the program in the repository. In the program management device, the program is registered in the repository only if the quality conditions are satisfied. Therefore it is capable of guaranteeing the quality of programs registered in the repository.

Generally, in a software development, the required quality level of the program changes according to the particular phase of the development process.

For example during initial development, ideas which have not yet passed the build stage and items which is not yet linkable with other modules are often registered in the repository in order to create prototypes and do trial-and-error work.

On the other hand, in the linking test phase, the assets in the repository are used in the build stage and also in the linking test so the quality must be at a level allowing linking to other modules as well as passing the build stage.

Also, when a problem occurs in the operating phase, the source code of the module used in the operating environment is sometimes corrected and reused. But in this case, that correction is done definitely and that the test which is previously passed must also be passed again here are required.

However, for example, JP-A NO. 2005-316685 discloses a program management device which checks all registered programs based on quality check items of the quality condition defining information. Therefore, in No. 2005-316685, it was not possible to check programs based on each check level of each phase of the development process.

The object of this invention is providing a file management system, a file management method, a support device thereof, and a program thereof, which is capable to guarantee third parties that no problems will occur by checking the different quality levels required in each phase of the development process and registering only high quality programs in the repository for those phases requiring high quality.

### SUMMARY OF THE INVENTION

An object of the present invention is to provide a file management system, a file management method, a support device thereof, and a program thereof, capable of checking the program quality at different standards for each phase of software development.

According to one aspect of the present invention, a file management system is provided that comprises a management server, and a support device which checks whether or not a program file satisfies a check rule for each program file, and sending said program file satisfying the check rule to the management server.

According to one aspect of the present invention, a file management method in a file management system in which a support device is connected to a management server is provided, the file management method comprising the step of: checking whether or not a program file satisfies a check rule for each program file; and sending the program files satisfying the check rule to the management server.

According to one aspect of the present invention, a support device connected to a management device is provided, which checks whether or not a program file satisfies a check rule for each program file and which sends said program files satisfying said check rule to said management server.

According to one aspect of the present invention, a computer readable medium recording thereon a program for enabling a computer to execute a file management method of a support device connected to a management server, is provided, the method comprising the step of: checking whether or not a program file satisfies a check rule for each program file; and sending the program files satisfying the check rule to the management server.

### BRIEF DESCRIPTION OF THE DRAWINGS

Other features and advantages of the invention will be made more apparent by the following detailed description and the accompanying drawings, wherein:

FIG. 1 is a block diagram showing the file management system of the first embodiment of this invention;

FIG. 2 is a drawing showing the data structure of the temporary storage device for the file management system;

FIG. 3 is a drawing showing the data structure of the storage device of the file management system;

FIG. 4 is a flow chart showing the processing procedure of the file management system;

FIG. 5 is a block diagram showing the file management system for the second embodiment of this invention;

FIG. 6 is a drawing showing the check results for the file management system;

FIG. 7 is a flow chart showing the processing procedure of the file management system.

In the drawings, the same reference numerals represent the same structural elements.

### DETAILED DESCRIPTION OF THE PREFERRED EMBODIMENTS

One unique feature of this invention is its capability to check the quality of the program at different standards for each phase of software development. Consequently, this invention is able to guarantee that others that no problem will occur when others use the program.

The file management system of this invention is operated by a computer controlled by a program. The CPU in the computer sends commands to each structural element in the computer based on the program, executes the specified processing which is required for operating the management device, for example processing for acquiring check programs and check conditions, and quality check processing. In the file management system of this invention, each process and each operation is performed by a specific means performing by utilizing both the program and the computer.

The program is stored beforehand in a storage medium such as a ROM or RAM, and executed by loading it into the applicable computer from the storage medium mounted in that computer. The program can also be loaded into a computer by way of a communication line.

The storage medium for storing the program is a storage device such as a semiconductor memory, magnetic disk, optical disk or other optional storage device capable of being loaded (read) by a computer.

A first embodiment of the present invention will be described in detail below.

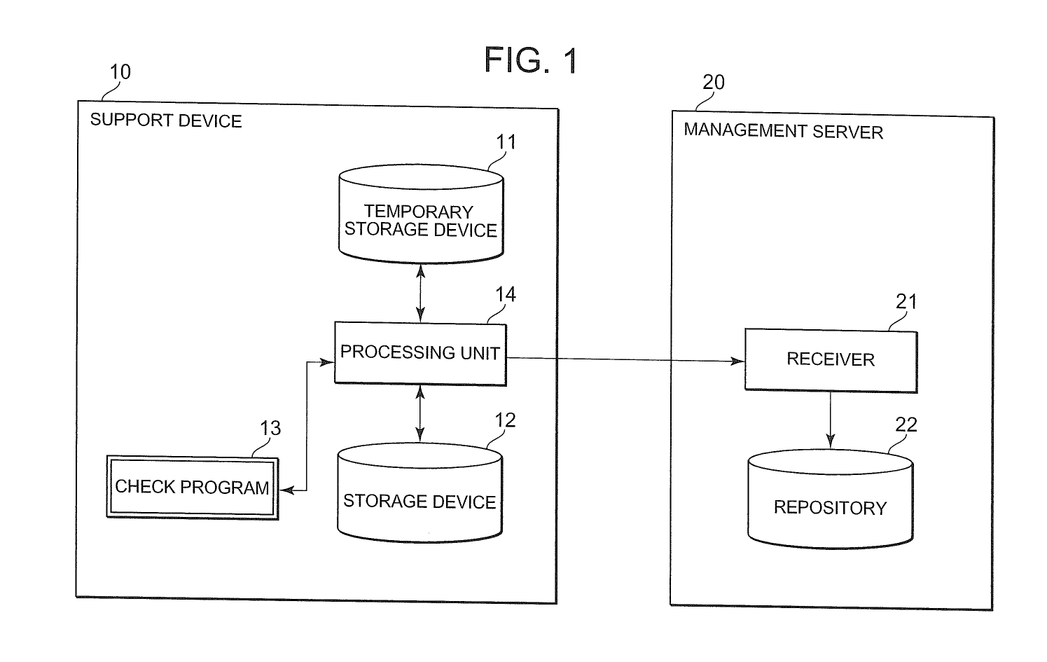

FIG. 1 is a block diagram showing the file management system of the first embodiment.

A file management system of the first embodiment as shown in FIG. 1 includes a support device 10, and a management server 20.

The support device 10 is an information processing device for checking the quality of the program, before registering that program in the repository. The support device 10 is for example a proxy server.

The support device 10 includes a temporary storage device 11, a storage device 12, a check program 13, and a processing unit 14.

The temporary storage device 11 is a storage device for storing program files scheduled to be registered in the repository.

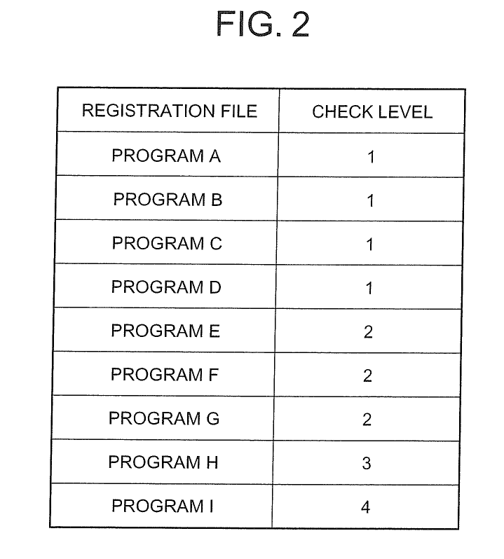

FIG. 2 is a table showing data stored in the temporary storage device 11. The names of the programs (assets) scheduled to be registered in the repository are stored in the field for the registration file, and a check level corresponded to each name of the program is also stored.

The check level is information for identifying a check program group executed for an asset.

In the first embodiment, the program itself scheduled for registration in the repository is stored in the temporary storage device 11. However, it is accessible that the program itself may be stored in the support device 10 or in the storage device 12 of the support device 10 or in an external storage device connected to the support device 10.

The storage device 12 is a storage device for storing the program to be checked, and the check rules for finding whether or not the product quality is satisfactory based on execution results of that program.

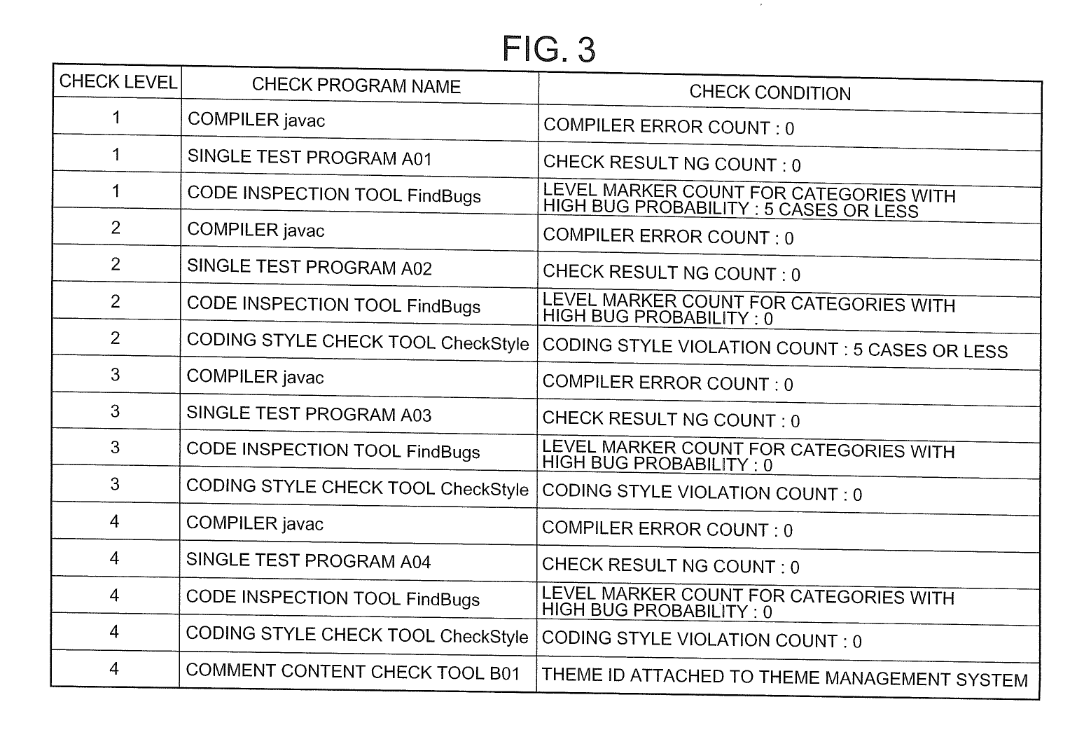

FIG. 3 is a drawing showing the data stored in the storage device 12. In the storage device 12, a check level, a check program corresponded to the check level and the check rule corresponded to each check program.

In Check level 1 for example, Compiler javac, Single test program A01, Code inspection tool (code inspection program) Find Bugs are stored as check program. Moreover, “Number of compilation errors shall be 0”, and “Number of errors (NG) in test results shall be 0”, and “Number of level marker cases for categories with a high probability of bugs shall be 5 or less” are stored as respective check rules.

The check program 13 is a program for checking the program file.

The processing unit 14 sets the name of the asset scheduled for registration in the registry and this check program 13 then starts up. When the check program 13 starts up, the CPU executes the asset on the memory in the support device 10 as the input information. The CPU then outputs the results (check results).

The processing unit 14 finds whether the program scheduled for registration in the repository satisfies the quality level needed for that phase, and sends only programs satisfying the required quality level to the management server 20.

More specifically, the processing unit 14 checks whether or not the program is stored in the temporary storage device 11, and if stored there, then acquires that program name and the matching check level.

If for example using the temporary storage device 11 shown in FIG. 2, then the processing unit 14 acquires the programs A, B, C, D, E, F, G, H, I as the program names, and acquires 1, 1, 1, 1, 2, 2, 2, 3, 4 as the respective matching check levels.

The processing unit 14 acquires the name of the check program 13, and the check rules matching the respective check programs 13 from the storage device 12 based on the check level acquired from the temporary storage device 11.

In the example of the first embodiment, the processing unit 14 acquires all the program names defined in the check levels 1, 2, 3, 4 from the storage device 12 shown in FIG. 3, and the check rules matching each of the program names.

Next, the processing unit 14 sets the acquired check program 13 whose argument is the names of the program scheduled to registered in the repository. And processing unit 14 makes the check program 13 execute based on the program which is input information. And processing unit 14 acquires the execution results.

The processing unit 14 also checks whether or not those check results satisfy the check rules.

When the check results for all check levels in the check program 13 satisfy the check rules, the processing unit 14 sends the applicable program to the management server 20.

The management server 20 is an information processing device for managing the connectivity and version of the numerous programs for software development, etc.

The management server 20 generally contains a function to store checkin assets (programs) in the repository; a function to extract (checkout) assets from the repository; a function to search the comments for versions identifying the asset that was stored; a function to search for the difference between versions identifying the asset that was stored, and a function for attaching a name (tag) for managing the asset that was stored, etc.

The management server 20 as shown in FIG. 1 contains a receiver 21, and a repository 22.

After receiving a program whose quality was confirmed from the support device 10 the receiver 21 registers it in the repository 22.

The repository 22 is a database (program file storage unit) for storing program files, and manages the file version and history, structure, (link between files).

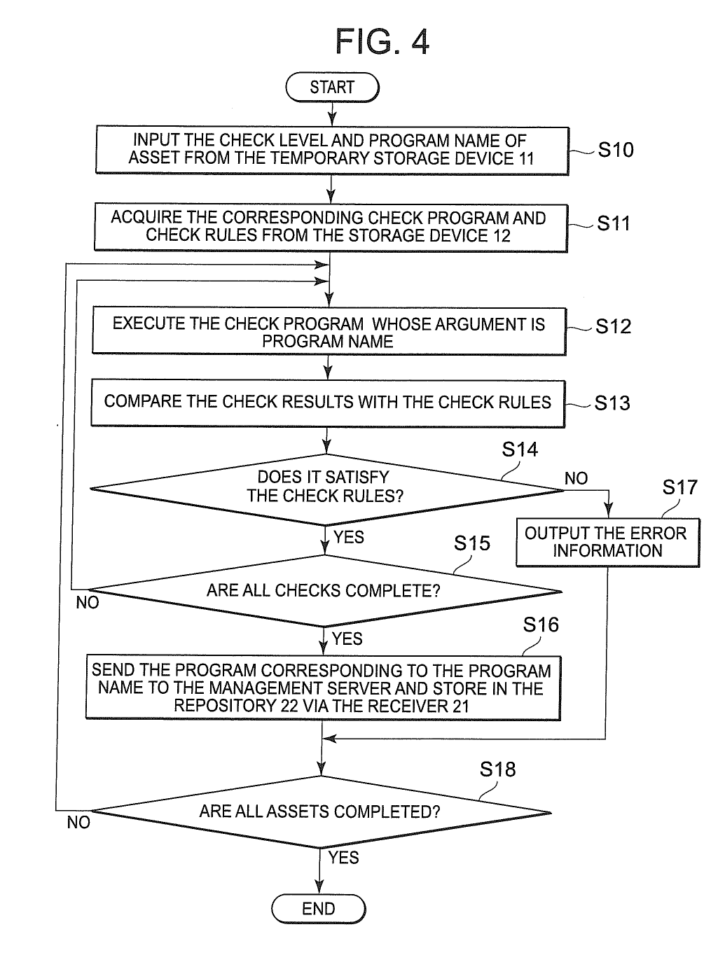

The processing procedure for the file management system of the first embodiment is described next while referring to FIG. 4.

FIG. 4 is a flow chart showing the processing procedure of the processing unit 14 in the support device 10 of the first embodiment.

First of all, the processing unit 14 acquires the name of the program (asset) scheduled for registration in the repository 22, and the check level matching each of the programs, from the temporary storage device 11 (step 10).

The processing unit 14 acquires the check program 13 matching each of the check levels which were input, and their check rules from the storage device 12 (step 11).

The processing unit 14 then executes the check program 13 in the sequence for the matching check levels of each asset (step 12).

The processing unit 14 then compares the check results and check rules corresponded to the check program 13 and checks whether or not the check results satisfy the check rules (step 13).

If the check results satisfy the check rules (Yes in step 14), then the processing unit 14 checks whether or not there is remaining check program 13 which has not been checked yet (step 15). If there is a remaining check program (No in step 15), then that remaining check program 13 is executed in the same way, and whether or not the check results satisfy the check rules is checked.

All check programs 13 matching the check level of the asset current being checked are then executed, and if those check results satisfy the check rules (Yes in step 15), then the processing unit 14 sends the applicable asset to the management server 20 (step 16).

At that time, the receiver 21 in the management server 20 stores the asset received from the processing unit 14, into the repository 22.

On the other hand, when the check results do not satisfy the check rules (No, in step 14), the processing unit 14 outputs the error information to the display devices in the support device 10 (step 17).

The processing unit 14 then executes the applicable processing from step 12 to step 17 for all assets that were input in step 10 (step 18).

In the first embodiment, if multiple check programs 13 are specified (defined) at each check level, at the time when a check results does not satisfy, the remaining check programs 13 are not executed and error information is output. However, it is acceptable to execute the remaining check programs 13 when there are check results which do not satisfy the check rules, Next, referring to FIG. 3, a specific example of the processing in the file management system of the first embodiment is described.

First of all, the processing unit 14 executes javac for the program A input from the temporary storage device 11. The processing unit 14 then checks whether or not the number of compilation errors is zero. If the number of compilation errors is zero at this time, then the processing unit 14 finds that the check rules are satisfied. If the number of compilation errors is one or more, the processing unit 14 finds that the check rules are not satisfied.

The processing unit 14 then executes A01 using the program A inputted from the temporary storage device 11 as the input information for the single test program A01 (usually, a temporary name for use by the developer). The processing unit 14 then checks whether or not the number of NG cases (errors) is zero. If the number of NG cases is zero at this time, then the processing unit 14 finds that the check rules are satisfied. If the number of NG cases is one or more, then the processing unit 14 finds that the check rules are not satisfied.

The processing unit 14 further executes FindBugs using the program A inputted from the temporary storage device 11 as the input information for the code inspection tool FindBugs. The processing unit 14 then checks whether the number of level marker cases showing a high probability of bugs is 5 or less. If the number of marker cases at this time is 5 or less, then the processing unit 14 finds the j check rules are satisfied, and if 6 or more finds the check rules are not satisfied.

If check results from the check program 13 (javac, A01, FindBugs) for all check levels of the program (program A) scheduled for registration in the repository satisfy the check results, then the processing unit 14 sends program A to the management server 20.

On the other hand, if there were one or more compilation errors in the results from executing for example the compiler javac, then the processing unit 14 displays that error information on the display of the support device 10, and does not execute other check programs 13.

However, it is acceptable that another check program 13 can be executed even if the check results do not satisfy the check rules.

The processing unit 14 checks the quality of all other assets input from the temporary storage device 11 in the same way, and sends the applicable assets to the management server 20 if check rules were satisfied at each asset's check level for all the check programs 13.

The processing unit 14 deletes assets sent to the management server 20 from the temporary storage device 11.

On the other hand, when the check program 13 which does not satisfy the check rules in the quality check processing, then the processing unit 14 does not send that asset to the management server 20, and outputs error information in the support device 10. This error information can also be sent to the management server 20.

The processing unit 14 does not delete assets, from the temporary storage device 11, which did not satisfy the check rules.

The file management system of the first embodiment as described above can therefore check the program quality at different standards at each development or test, operation, or detailed process stage.

In other words, a check can be made in any process at different quality levels to determine if the quality of the program was satisfactory or not and only those programs confirmed as satisfactory are then registered as successful results in the repository of the management server.

Therefore, the file management system of this embodiment can be applied for the different software development processes.

Moreover, only high quality programs can be registered in the repository in phases where high quality is required, so third parties can be assured that no problems will occur when others use the program.

The file management system of the first embodiment has the further merit that the preexisting management server 20 can be used unchanged and so is easy to incorporate into the system.

Next, a second embodiment of the present invention will be described in detail.

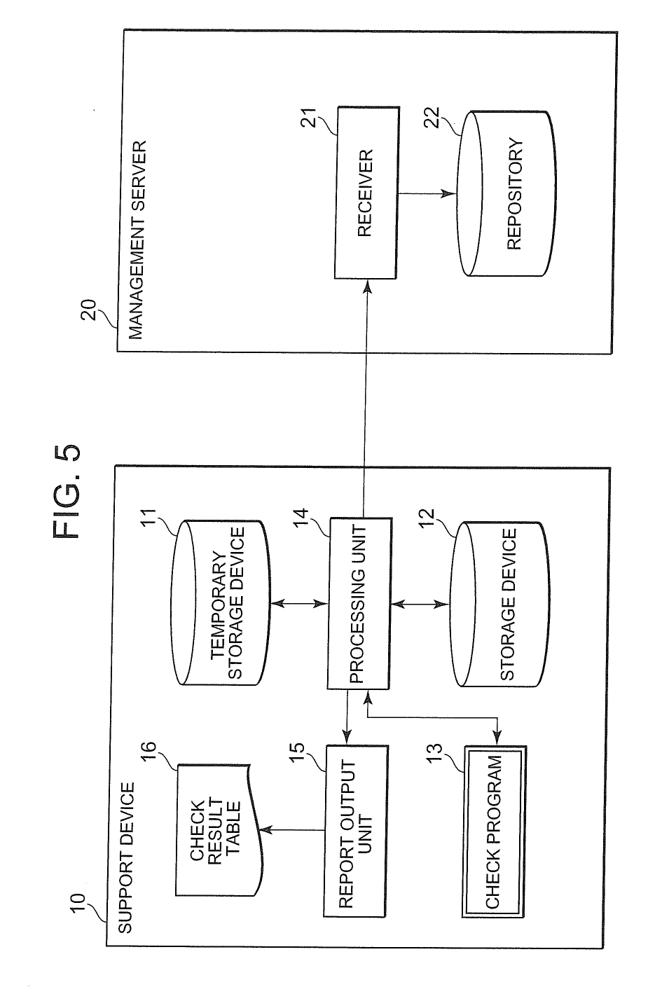

FIG. 5 is a block diagram showing the file management system of the second embodiment of this invention.

The second embodiment differs from the first embodiment in the point that the processing unit 14 can output a report of check results. In all other points this embodiment is the same as the first embodiment.

In addition to the structure of the first embodiment, the file management system of the second embodiment as shown in FIG. 5 includes a report output unit 5 and a check result table 16 in the support device 10.

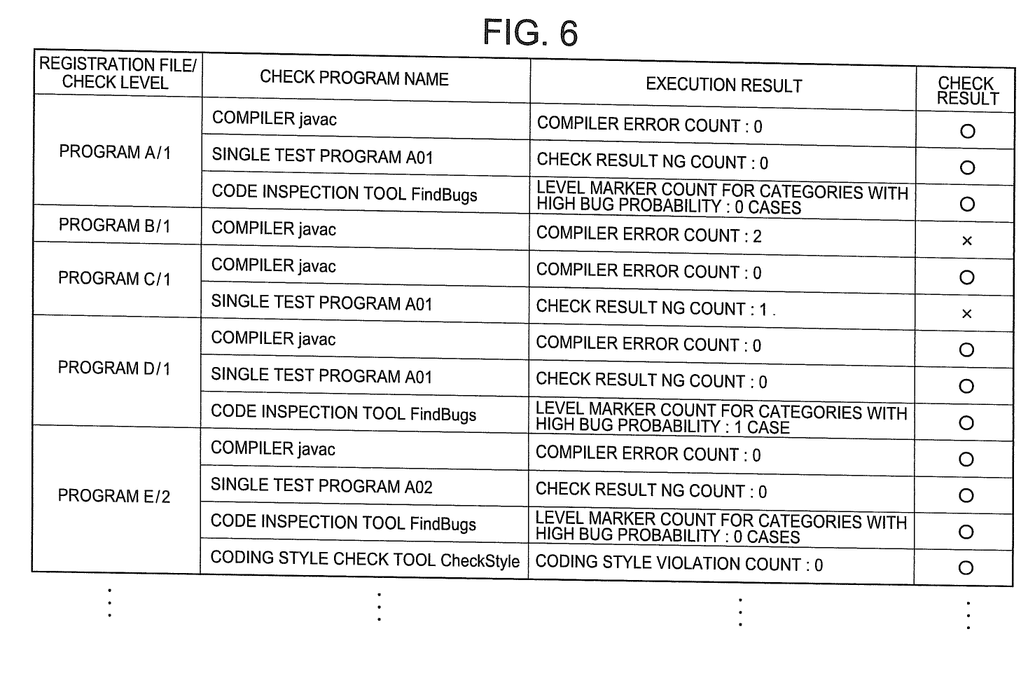

The report output unit 15 receives from the processing unit 14 the check results showing whether or not the check results for the check program 13 satisfy the check rules. The report output unit 15 then makes a list of the received check results, and outputs that list to the check result table 16. FIG. 6 shows an example of the check result table 16.

The report output unit 15 outputs the check result table 16 to a display device not shown in the drawing in the support device 10. The report output unit 15 can make a print out utilizing a printing device not shown in the drawing.

Moreover, the check rules stored in the storage device 12 may also be output as the check result table 16.

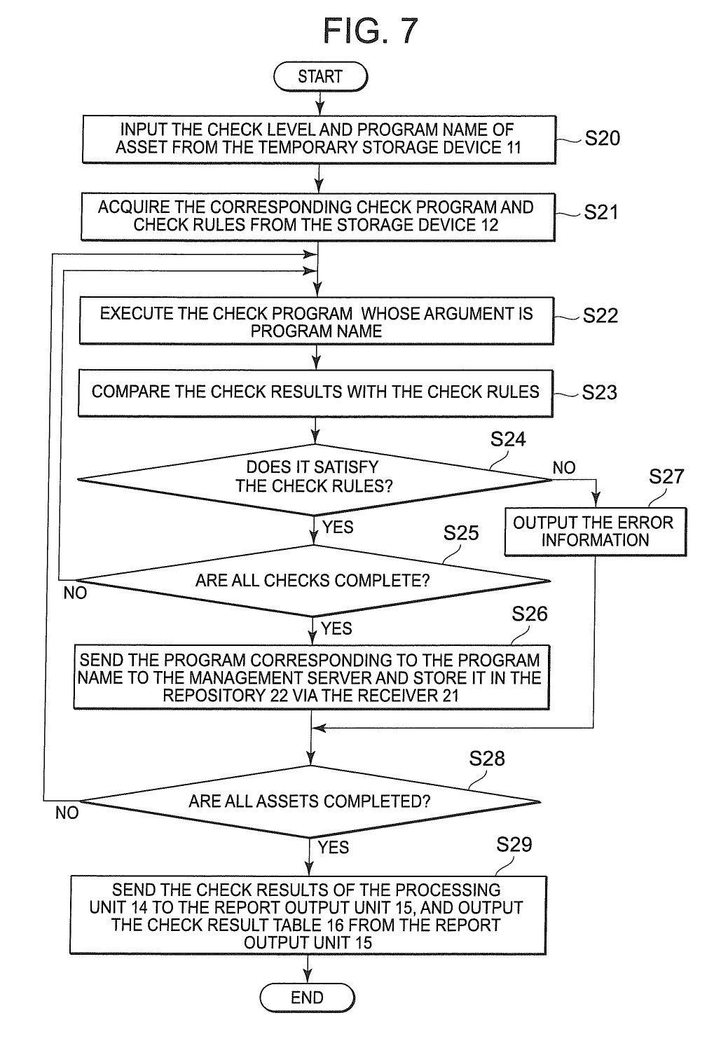

The process procedure of the file management system of the second embodiment is described next while referring to FIG. 7.

FIG. 7 is a flow chart for showing the processing unit 14 processing procedure in the support device 10 of the second embodiment.

The operation from step where the processing unit 14 acquires the program name of the asset and the check level from the temporary storage device 1, to the step for completing the check of all assets (step 20 through step 28) is identical to the operation in the first embodiment (step 10 through step 18).

In the second embodiment, after step 28, the processing unit 14 sends to the report output unit 15, check results showing whether or not the check results of all check programs 13 satisfy the check rules. The report output unit 15 then outputs the received check results as the check result table 16 (step 29).

In the file management system of the second embodiment, the quality check results of the program registered in the repository can be confirmed by referring to the check result table 16 so that a log of the quality check process is output to the check result table 16.

Also, if configured to dump the contents registered in the storage device 12 into the check result table 16, then besides being able to confirm the process definition for ensuring quality of the asset within the repository, the applicable process can also be confirmed to be operating correctly based on the log of the check process.

This invention is not limited to the above embodiments and needless to say, a diverse range of changes and modifications not departing from the spirit and scope of this invention are possible.

For example, changes can be made by establishing another field in the temporary storage device 11 and the storage means 12 for making more detailed settings.

Although, in the first and second embodiment of the present invention, the configuration where the support device 10 has both a temporary storage device 11 and a storage device 12, it is accessible to be the configuration where the support device 10 has a only storage device 12. In the configuration, the program files scheduled to be registered in the repository are registered in a storage device 12.

While this invention has been described in conjunction with the preferred embodiments described above, it will now be possible for those skilled in the art to put this invention into practice in various other manners.

What is claimed is:

1. A file management system comprising:
a management server; and
a support device which checks whether or not a program file satisfies a check rule for each program file, and sending said program file satisfying said check rule to said management server.

2. The file management system according to claim 1, wherein said support device comprises:
a storage device which includes a check file; and
a processing unit,
wherein said check file has a check level, a check program corresponded to said check level for checking said program file and said check rule corresponded to each check program, and
wherein, based on said check file, said processing unit checks whether or not said program file satisfies said check rule by executing said check program corresponding to said check level of said program file.

3. The file management system according to claim 2,
wherein said storage device includes said program file to be checked by said processing unit,
said processing unit deletes said program file satisfying said check rule from said storage device after sending said program file satisfying said check rule.

4. The file management system according to claim 2,
said processing unit sends said program file to said management server when all check programs corresponding to said check level of said program file satisfy said check rules corresponded to each check program.

5. The file management system according to claim 4,
when a check program in a plurality of said check programs does not satisfy said check rule, said processing unit does not execute the rest of said check program.

6. The file management system according to claim 4, further comprising a report output unit,
wherein said processing unit sends a check result of said program file to said report output unit, and
wherein said report output unit outputs said received check result.

7. A file management method in a file management system in which a support device is connected to a management server, the file management method comprising the step of:
checking whether or not a program file satisfies a check rule for each program file; and
sending said program files satisfying said check rule to said management server.

8. The file management method according to claim 7, wherein the file management system has a check file having a check level, a check program, corresponded to said check level, for checking said program file and said check rule corresponded to each check program,
wherein the step of checking checks whether or not said program file satisfies said check rule by executing said check program corresponding to said check level of said program file based on said check file.

9. The file management method according to claim 8,
wherein the step of sending sends said program file to said management server when all check programs corresponding to said check level of said program file satisfy said check rules for each check program.

10. A support device connected to a management device, which checks whether or not a program file satisfies a check rule for each program file and which sends said program files satisfying said check rule to said management server.

11. The support device according to claim 10, which comprising:
a storage device which includes a check file; and
a processing unit,
wherein said check file has a check level, a check program, corresponded to said check level, for checking said program file and said check rule corresponded to each check program, and
wherein, based on said check file, said processing unit checks whether or not said program file satisfies said check rule by executing said check program corresponding to said check level of said program file.

12. The support device according to claim 11, wherein said processing unit sends said program file to said management server when all check programs corresponding to said check level of said input program file satisfy said check rules for each check program.

13. A computer readable medium recording thereon a program for enabling a computer to execute a file management method of a support device connected to a management server, the method comprising the step of:
checking whether or not a program file satisfies a check rule for each program file; and
sending said program files satisfying said check rule to said management server.

14. The computer readable medium according to claim 13,
wherein the step of checking checks whether or not said program file satisfies said check rule by executing said check program corresponding to said check level of said program file based on said check file.

15. The computer readable medium according to claim 14,
wherein the step of sending sends said program file to said management server when all check programs corresponding to said check level of said program file satisfy said check rules for each check program.
